(19) United States
(12) Patent Application Publication
(10) Pub. No.: US 2025/0058278 A1
(43) Pub. Date: Feb. 20, 2025

(54) Full-Automatic Ultra-Filtration Equipment

(71) Applicant: Challenge IM (Beijing) Technology Co., Ltd., Beijing (CN)

(72) Inventors: Limiao Liu, Beijing (CN); Tongqiang Cui, Beijing (CN); Fengxue Wang, Beijing (CN); Zhiqiang An, Beijing (CN); Weichao Sui, Beijing (CN)

(21) Appl. No.: 18/789,897

(22) Filed: Jul. 31, 2024

(30) Foreign Application Priority Data
Aug. 16, 2023 (CN) 202322202654.X

(51) Int. Cl. B01D 61/18; B01D 61/14; B01D 61/22

(52) U.S. Cl. CPC B01D 61/18; B01D 61/145; B01D 61/22; B01D 2311/16; B01D 2313/18; B01D 2317/04

(57) ABSTRACT

The present disclosure provides full-automatic ultra-filtration equipment, and relates to the technical field of biopharmaceutical equipment to solve the technical problems that the labor cost is wasted and the health standard for biological pharmacy is not met since a reflux end of the traditional ultra-filtration equipment has only one outlet pipeline and different feed liquids in different process stages cannot be collected automatically after outflowing from the reflux end. The device includes a main loop container, an ultra-filtration membrane and a control module. The ultra-filtration membrane at least includes an input end and a reflux end. An outlet of the main loop container is connected with the input end of the ultra-filtration membrane through a first pipeline, and the first pipeline is provided with a main loop pump. The reflux end is provided with a reflux pipeline, a first control assembly and a plurality of first outlet branch pipelines.

### CROSS REFERENCE TO RELATED APPLICATION

This application claims the benefit of and takes priority from Chinese Patent Application No. 202322202654.X filed on Aug. 16, 2023, the contents of which are herein incorporated by reference.

### TECHNICAL FIELD

The present disclosure relates to the technical field of biopharmaceutical equipment, in particular to full-automatic ultra-filtration equipment.

### BACKGROUND

Ultra-filtration, also known as tangential flow filtration, refers to biopharmaceutical equipment. Target products with different molecular weights, molecular sizes and other characteristics are separated by using the filter membrane mainly.

The filter membrane is provided with an inlet end, a reflux end and a permeation end. The feed liquid enters into the membrane from the inlet end, and the components of the feed liquid with different molecular weights flow out from the permeation end and the reflux end respectively. The ultra-filtration equipment has multiple stages in the entire production or experimental process, each stage requires different liquids, and different feed liquids flow out from the reflux end after passing through the filter membrane.

The applicant finds that at least the following technical problems exist in the prior art.

The labor cost is wasted and the health standard for biological pharmacy is not met extremely since a reflux end of the traditional ultra-filtration equipment has only one outlet pipeline, different feed liquids in different process stages are collected or drained after outflowing from the reflux end by manually moving the pipeline, and the process of manually moving the pipeline is complicated to easily result in liquid leakage.

### SUMMARY

The present disclosure aims to provide full-automatic ultra-filtration equipment to solve the technical problems that the labor cost is wasted and the health standard for biological pharmacy is not met extremely since a reflux end of the traditional ultra-filtration equipment has only one outlet pipeline, different feed liquids in different process stages are collected or drained after outflowing from the reflux end by manually moving the pipeline, and the process of manually moving the pipeline is complicated to easily result in liquid leakage. Various technical effects generated by a preferred technical scheme in various technical schemes provided by the present disclosure are explained in detail as follow.

To achieve the above purpose, the present disclosure adopts the following technical scheme.

Full-automatic ultra-filtration equipment provided by the present disclosure includes a main loop container, an ultra-filtration membrane and a control module, and the ultra-filtration membrane at least including an input end and a reflux end.

An outlet of the main loop container is connected with the input end of the ultra-filtration membrane through a first pipeline, and the first pipeline is provided with a main loop pump.

The reflux end is provided with a reflux pipeline, a first control assembly and a plurality of first outlet branch pipelines, each first outlet branch pipeline is respectively connected to one container, and the first control assembly is used for controlling the connection and disconnection of the first outlet branch pipeline and the reflux pipeline.

The main loop pump and the first control assembly are both electrically connected with the control module.

Preferably, the reflux end is also provided with a second pipeline, the second pipeline is connected with an inlet of the main loop container, and the first control assembly controls the connection and disconnection of the second pipeline and the reflux pipeline.

Preferably, the first control assembly is a rotary switching valve, and the reflux pipeline, the first outlet branch pipelines and the second pipeline are all connected with the rotary switching valve.

Preferably, the first control assembly includes a plurality of switch valves, and the switch valves are respectively arranged on the first outlet branch pipelines and the second pipeline.

Preferably, the ultra-filtration membrane is also provided with a penetration end, and the penetration end is provided with a third pipeline, a second control assembly and a plurality of second outlet branch pipelines.

Each second outlet branch pipeline is respectively connected to one container, and the first control assembly is used for controlling the connection and disconnection of the second outlet branch pipeline and the third pipeline.

The second control assembly is electrically connected with the control module.

Preferably, the second control assembly is a rotary switching valve, and the third pipeline and the second outlet branch pipelines are all connected with the rotary switching valve.

Preferably, the first control assembly includes a plurality of switch valves, and the switch valves are respectively arranged on the second outlet branch pipelines.

Preferably, the first pipeline, the reflux pipeline and the third pipeline are all provided with a pressure monitoring device.

The full-automatic ultra-filtration equipment provided by the present disclosure includes a main loop container, an ultra-filtration membrane and a control module. The outlet of the main loop container is arranged to be connected with the input end of the ultra-filtration membrane through the first pipeline, and the main loop pump is arranged on an outlet pipeline of the main loop container. When in use, liquid in the main loop container is fed into the ultra-filtration membrane through the input end by the main loop container, and the liquid flows out from the reflux end after intercepted by the ultra-filtration membrane. The reflux end is provided with the first control assembly and the first outlet branch pipelines respectively connected with the container, and different liquids are collected into different containers through the control of the first control assembly, so that automatic collection of different liquids is realized, and the outlet pipeline of the reflux end does not need to be removed in the whole process. In cooperation with the arrangement of the main loop pump and the first control assembly which are both electrically connected with the control module, unmanned watching is not needed, and the equipment is high in automation degree and high in cleanliness and meets the sanitary requirement in the biological pharmacy industry, so that the problems in the prior art that the reflux end of the ultra-filtration equipment is single in outlet pipeline and the liquid recovery process is complicated and prone to leakage are solved.

### BRIEF DESCRIPTION OF THE DRAWINGS

In order to illustrate the technical scheme in the embodiment of the present disclosure or in the prior art more clearly, the attached figures needing to be used in the embodiment or in the description in the prior art are simply described. Apparently, the embodiments in the following description are merely a part rather than all of the embodiments of the present disclosure. For any person skilled in the art, under the premise of without contributing creative labor, other attached figures further can be obtained according to these attached figures.

FIG. 1 is a structural schematic diagram of full-automatic ultra-filtration equipment in one embodiment of the present disclosure.

FIG. 2 is a control schematic diagram of full-automatic ultra-filtration equipment in the present disclosure.

FIG. 3 is a structural schematic diagram of full-automatic ultra-filtration equipment in another embodiment of the present disclosure.

Reference signs: 1, main loop container; 2, ultra-filtration membrane; 3, control module; 4, main loop pump; 5, first control assembly; 6, second control assembly; 7, pressure monitoring device; 10, first pipeline; 11, inlet of main loop container; 12, outlet of main loop container; 20, second pipeline; 21, input end; 22, reflux end; 23, penetration end; 30, third pipeline; 40, first outlet branch pipeline; 50, second outlet branch pipeline; and 220, reflux pipeline.

### DETAILED DESCRIPTION OF THE EMBODIMENTS

In order to make the purpose, technical scheme and advantages of the present disclosure clearer, the technical scheme of the present disclosure is described in detail as follows. Apparently, the embodiments in the following description are merely a part rather than all of the embodiments of the present disclosure. Based on the embodiment in the present disclosure, all other embodiments obtained by the ordinary technical staff in the art under the premise of without contributing creative labor belong to the scope protected by the present disclosure.

In the description of the present disclosure, it needs to be illustrated that the indicative direction or position relations of the terms such as “center”, “side direction”, “length”, “width”, “upper”, “lower”, “front”, “rear”, “left”, “right”, “vertical”, “horizontal”, “top”, “bottom”, “inside”, “outside” and “side” are direction or position relations illustrated based on the attached figures, just for facilitating the description of the present disclosure and simplifying the description, but not for indicating or hinting that the indicated device or element must be in a specific direction and is constructed and operated in the specific direction, the terms cannot be understood as the restriction of the present disclosure.

In the description of the present disclosure, it further needs to be illustrated that, except as otherwise noted, the terms such as “mount”, “link” and “connect” should be generally understood. For example, the components can be fixedly connected, and also can be detachably connected or integrally connected; the components can be mechanically connected, and also can be electrically connected; and the components can be directly connected, and also can be indirectly connected through an intermediate. For those skilled in the art, the specific meanings of the terms in the present disclosure can be visually understood according to specific conditions.

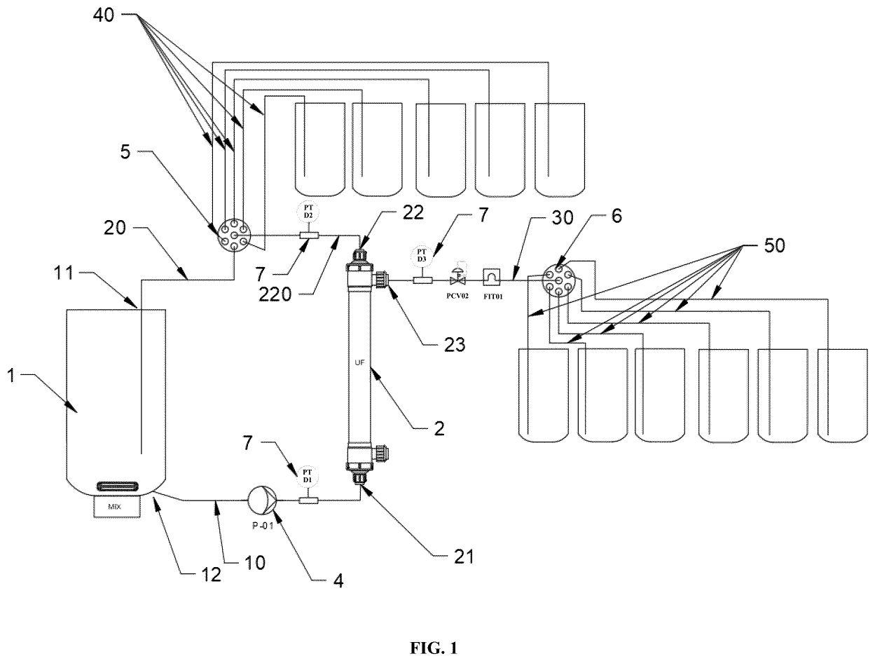

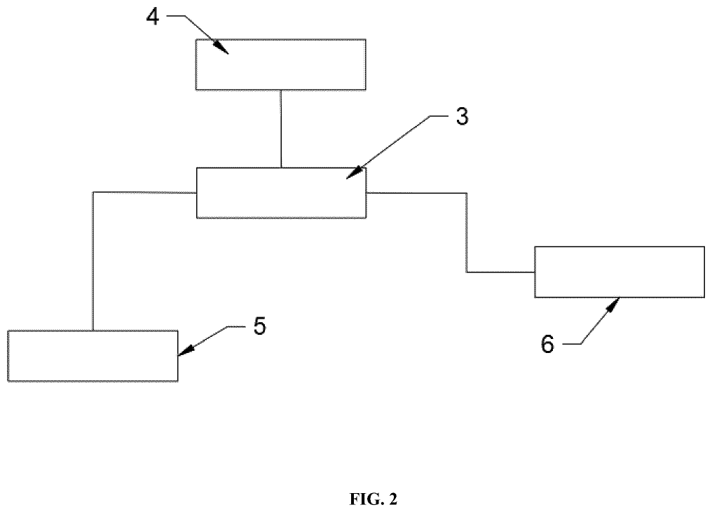

The present disclosure provides full-automatic ultra-filtration equipment. FIG. 1 is a structural schematic diagram in the embodiment. FIG. 2 is a control schematic diagram in the embodiment. As shown in FIG. 1 and FIG. 2, the full-automatic ultra-filtration equipment includes a main loop container 1, an ultra-filtration membrane 2 and a control module 3. The ultra-filtration membrane 2 at least includes an input end 21 and a reflux end 22.

Wherein, an outlet 12 of the main loop container is connected with the input end 21 of the ultra-filtration membrane 2 through a first pipeline 10, and the first pipeline 10 is provided with a main loop pump 4. The outlet of the main loop container 1 is arranged to be connected with the input end 21 of the ultra-filtration membrane 2 through the first pipeline 10, and the main loop pump 4 is arranged on an outlet pipeline of the main loop container 1. When in use, liquid in the main loop container 1 is fed into the ultra-filtration membrane 2 through the input end by the main loop container 4, and the liquid flows out from the reflux end 22 after intercepted by the ultra-filtration membrane 2.

The reflux end 22 is provided with a reflux pipeline 220, a first control assembly 5 and a plurality of first outlet branch pipelines 40, each first outlet branch pipeline 40 is respectively connected to one container, and the first control assembly 5 is used for controlling the connection and disconnection of the first outlet branch pipeline 40 and the reflux pipeline 220. The reflux end 22 is provided with the first control assembly 5 and the first outlet branch pipelines 40 respectively connected with the container, and different liquids are collected into different containers through the control of the first control assembly 5, so that automatic collection of different liquids is realized, the outlet pipeline at the reflux end does not need to be moved in the whole process, and the equipment is more convenient to use.

As shown in FIG. 2, the main loop pump 4 and the first control assembly 5 are both electrically connected with the control module 3. The main loop pump 4 and the first control assembly 5 are intelligently controlled by the control module 3, unmanned watching is realized, and the equipment is high in automation degree and high in cleanliness and meets the sanitary requirements in the biological pharmacy industry.

As an optional embodiment, the reflux end 22 is also provided with a second pipeline 20, the second pipeline 20 is connected with an inlet 11 of the main loop container, and the first control assembly 5 controls the connection and disconnection of the second pipeline 20 and the reflux pipeline.

In the embodiment, the first control assembly 5 is a rotary switching valve, and the reflux pipeline 220, the first outlet branch pipelines 40 and the second pipeline 20 are all connected with the rotary switching valve. The rotary switching valve includes one inlet and a plurality of outlets. The input is connected with the reflux end 22 of the ultra-filtration membrane. Each outlet is respectively connected with one first outlet branch pipeline 40 and the second pipeline 20.

According to the working principle of the rotary switching valve, the inlet and outlets are respectively arranged on a stator and a rotor. By rotating the rotor, the outlets can be connected with the inlet respectively. When one of the outlets is connected with the inlet, the other outlets are in a closed state. In the embodiment, the rotary switching valve is arranged to be electrically connected with the control module 3. The control module 3 controls the rotor of the rotary switching valve to rotate according to the requirements in different process stages, so that the corresponding outlet is connected with the inlet, and then collection for different liquids is realized.

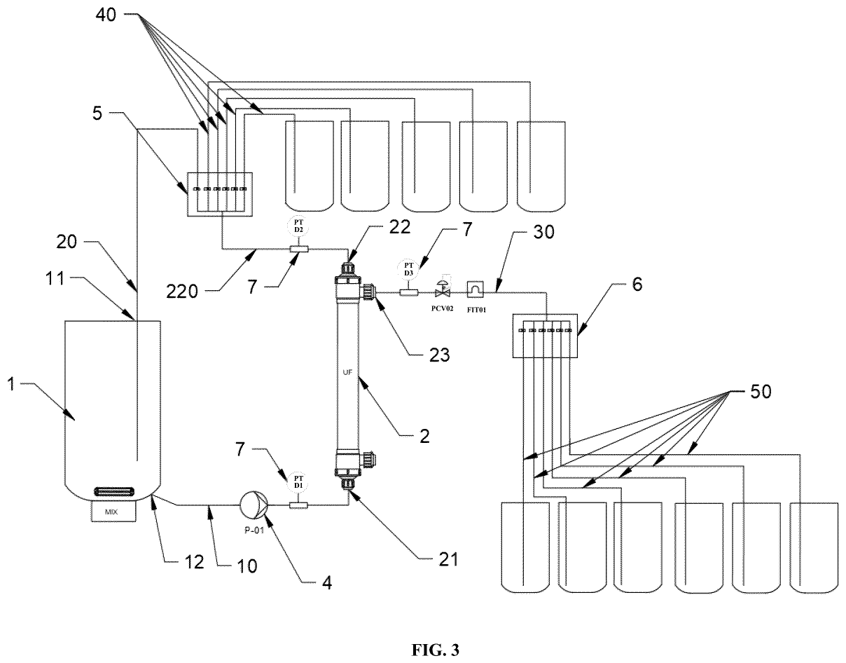

During actual production and application, as shown in FIG. 3, the first control assembly 5 includes a plurality of switch valves, and the switch valves are respectively arranged on the first outlet branch pipelines 40 and the second pipeline 20. The switch valves are respectively arranged on the different first outlet branch pipelines 40 and the second pipeline so as to control the connection and disconnection of the outlet branch pipelines and the second pipeline 20.

The switch valve is electrically connected with the control module 3. The control module 3 can control the opening and closing of each switch valve, and then the branch pipeline or the second pipeline 20 is connected or closed. Specifically, the control module 3 can control one of the switch valves to open according to the requirements in different process stages, and the other switch valves are closed, so that one of the first outlet branch pipelines 40 or the second pipeline 20 is connected with the reflux end 22, and then collection for different liquids is realized.

As an optional embodiment, the ultra-filtration membrane 2 is also provided with a penetration end 23, and the penetration end 23 is provided with a third pipeline 30, a second control assembly 6 and a plurality of second outlet branch pipelines 50.

Wherein, each second outlet branch pipeline 50 is respectively connected to one container, and the first control assembly 5 is used for controlling the connection and disconnection of the second outlet branch pipeline 50 and the third pipeline 30; and the second control assembly 6 is electrically connected with the control module 3.

The second control assembly 6 in the embodiment can be a rotary switching valve or include a plurality of switch valves. Specifically, the second control assembly 6 is a rotary switching valve, and the third pipeline 30 and the second outlet branch pipelines 50 are all connected with the rotary switching valve. The second control assembly also can include a plurality of switch valves, and the switch valves are respectively arranged on the second outlet branch pipelines 50. The function and principle are the same as those of the above-mentioned rotary switching valve and the above-mentioned switch valves.

As an optional embodiment, the first pipeline 10, the reflux pipeline 220 and the third pipeline 30 are all provided with a pressure monitoring device 7. In the embodiment, the pressure monitoring device 7 is a pressure gage, and is used for monitoring the pressure of the first pipeline 10, the reflux pipeline 220 and the third pipeline 30 in real time so as to ensure the use safety.

The foregoing descriptions are merely specific embodiments of the disclosure, but are not intended to limit the protection scope of the disclosure. Any variation or replacement readily figured out by a person skilled in the art within the technical scope disclosed in the disclosure shall fall within the protection scope of the disclosure. Therefore, the protection scope of the present disclosure shall be subject to the protection scope of the claims. cm What is claimed is:

1. Full-automatic ultra-filtration equipment, comprising a main loop container, an ultra-filtration membrane and a control module, and the ultra-filtration membrane at least comprising an input end and a reflux end, wherein
an outlet of the main loop container is connected with the input end of the ultra-filtration membrane through a first pipeline, and the first pipeline is provided with a main loop pump;
the reflux end is provided with a reflux pipeline, a first control assembly and a plurality of first outlet branch pipelines, each first outlet branch pipeline is respectively connected to one container, and the first control assembly is used for controlling the connection and disconnection of the first outlet branch pipeline and the reflux pipeline; and
the main loop pump and the first control assembly are both electrically connected with the control module.

2. The full-automatic ultra-filtration equipment according to claim 1, wherein the reflux end is also provided with a second pipeline, the second pipeline is connected with an inlet of the main loop container, and the first control assembly controls the connection and disconnection of the second pipeline and the reflux pipeline.

3. The full-automatic ultra-filtration equipment according to claim 2, wherein the first control assembly is a rotary switching valve, and the reflux pipeline, the first outlet branch pipelines and the second pipeline are all connected with the rotary switching valve.

4. The full-automatic ultra-filtration equipment according to claim 2, wherein the first control assembly comprises a plurality of switch valves, and the switch valves are respectively arranged on the first outlet branch pipelines and the second pipeline.

5. The full-automatic ultra-filtration equipment according to claim 1, wherein the ultra-filtration membrane is also provided with a penetration end, and the penetration end is provided with a third pipeline, a second control assembly and a plurality of second outlet branch pipelines, wherein
each second outlet branch pipeline is respectively connected to one container, and the first control assembly is used for controlling the connection and disconnection of the second outlet branch pipeline and the third pipeline; and
the second control assembly is electrically connected with the control module.

6. The full-automatic ultra-filtration equipment according to claim 5, wherein the second control assembly is a rotary switching valve, and the third pipeline and the second outlet branch pipelines are all connected with the rotary switching valve.

7. The full-automatic ultra-filtration equipment according to claim 5, wherein the second control assembly comprises a plurality of switch valves, and the switch valves are respectively arranged on the second outlet branch pipelines.

8. The full-automatic ultra-filtration equipment according to claim 5, wherein the first pipeline, the reflux pipeline and the third pipeline are all provided with a pressure monitoring device.
